(19) United States
(12) Patent Application Publication
(10) Pub. No.: US 2023/0138474 A1
(43) Pub. Date: May 4, 2023

(54) WATERCRAFT COMPRISING A POSITIONING SYSTEM

(71) Applicant: DEMCON UNMANNED SYSTEMS B.V., Enschede (NL)

(72) Inventors: Bartholomeus Johannesz VRIJLING, Enschede (NL); Tjalling TALSMA, Enschede (NL); Fedor Pieter Ferdinand ESTER, Enschede (NL); Yannic Cornelius Joseph VAN MOERKERK, Enschede (NL)

(73) Assignee: DEMCON UNMANNED SYSTEMS B.V., Enschede (NL)

(21) Appl. No.: 17/915,402

(22) PCT Filed: Apr. 6, 2021
(86) PCT No.: PCT/NL2021/050222

§ 371 Date: Sep. 28, 2022

(30) Foreign Application Priority Data
Apr. 6, 2020 (NL) 2025284

(51) Int. Cl. B63H 25/42; B63H 5/07

(52) U.S. Cl. CPC B63H 25/42; B63H 5/07; B63H 2005/075; B63B 2035/007

(57) ABSTRACT

A watercraft includes a positioning system having a controller and at least two stationary mounted propulsion units that are stationary with respect to the watercraft for generating a forward and backward thrust with respect to the respective propulsion unit in a respectively fixed direction with respect to the watercraft. The controller is arranged for individually controlling the thrust generated by each of the two propulsion units for moving and steering the watercraft.

The invention relates to a watercraft comprising a positioning system, in particular a dynamic positioning system, the positioning system and a method of controlling the watercraft comprising the (dynamic) positioning system.

For maintaining the position of a watercraft, such as ships, vessels and boats, dynamic positioning systems are used. These systems are often computer-controlled to automatically maintain a vessel's position and heading by using its own means of propulsion. Dynamic positioning first came up in the 1960's to enable offshore drilling in locations where the use of jack-up vessels and/or anchoring was no longer possible or economical. These dynamic positioning vessels are often fitted with a number of, often four or more, steerable propeller pods that are fitted to hull of the vessel. The vessel is maintained in the position by the varying the thrust generated by the pods and by steering these pods to direct the thrust in the correct directions.

These propeller pods are, also due to the fact that they need to be steerable, relatively expensive, such that these systems are typically only used for expensive offshore installation vessels. Due to the large amount of movable parts, these systems require costly and constant maintenance. These costs and technical complexity thereby also do not allow one to simply apply these systems on smaller types of vessels, such as for instance small autonomously operated vessels.

It is a goal of the present invention, next to other goals, to provide for a watercraft comprising a positioning system that is more cost-efficient and/or is suited for smaller vessels, wherein at least one of the above-mentioned problems is at least partially alleviated.

This goal, amongst other goals, is met by a watercraft comprising a positioning system comprising a controller and at least two stationary mounted propulsion units that are stationary with respect to the watercraft for generating a forward and backward thrust with respect to the respective propulsion unit in a respectively fixed direction with respect to the watercraft; and wherein the controller is arranged for individually controlling the thrust generated by each of the two propulsion units for moving and steering the watercraft.

As the propulsion units are fixedly attached to the watercraft, such as a boat, vessel and or ship, in particular an autonomous surface vehicle, relatively simple and robust propulsion units can be used. The propulsion units cannot rotate for directing thrust, such that the construction of the watercraft itself is also simplified. By individually controlling the propulsion units, or at least one thereof, in particular the amount of thrust generated and the direction (i.e. forward or backward) of the generated thrust by the respective propulsion units, a resultant trust and/or moment with respect to a centre of gravity, or rotation point, of the respective watercraft can be modified. Hence, hereby this enables steering the watercraft without the use of a rudder for steering, or rotational propulsion unit for directing the thrust, such that the amount of movable parts is reduced, simplifying construction and reducing maintenance costs. It is noted here that, wherever the text refers to the centre of gravity, this can also be replaced throughout the text by (i.e. amended by) a centre of rotation or rotation point.

At least one of the stationary mounted propulsion units, in a preferred embodiment of the watercraft, is directed such that the respective forward and backward thrusts generate respective moments around the centre of gravity of the watercraft. In use, the respective moment generated by the thrust that is generated by the at least one of the stationary mounted propulsion units, enables rotating the water craft in yaw direction such that efficient turning can be enabled.

In a preferred embodiment, the two stationary mounted propulsion units are mounted on opposite sides of the centre of gravity of the watercraft. Hereby, the variation of the thrust of the respective individual propulsion units leads to efficiently varying the moments around the centre of gravity and/or centre of rotation of the watercraft and thereby in controlling at least surge and yaw motions.

In a preferred embodiment of the watercraft, the two stationary mounted propulsion units are arranged mirror symmetric with respect to a line of mirror symmetry of the watercraft. The line of mirror symmetry can be a virtual centre line of the watercraft running from bow to stern through the centre of gravity. Such a setup simplifies controlling the individual propulsion units, as an equal amount of forward or backward thrust delivered by each propulsion unit will lead to the watercraft going respectively forward or backward in a straight line (i.e. surge direction), whereby an efficient setup can be obtained for a watercraft intended to cover large distances. In addition, the moment arm of the respective thrusts around the centre of gravity, or the centre of rotation, of the watercraft is equal for both of the respective stationary mounted propulsion units. Hereby, powering the one or the other of the two stationary mounted propulsion units allows for rotating in yaw direction and steering the watercraft in respective port and starboard directions.

It is preferred that the two stationary mounted propulsion units are arranged at an angle with respect to each other. As the stationary mounted propulsion units are arranged at an angle with respect to each other, each propulsion unit generates its respective thrust in a predefined direction (as seen in a plane span by the sway and surge direction of the watercraft), wherein the respective thrust could also result in a moment around the centre of gravity of the watercraft. Hence, by mounting the propulsion units at certain predefined angles and positions, the handling characteristic of the watercraft can be optimized for a certain purpose. For instance, a setup wherein the angles are chosen such that a moment arm (of the thrust generated by a propulsion unit) with respect to the centre of gravity is increased, results in a shortened turning radius, which would be more suitable for a more nimble watercraft.

In a preferred embodiment, wherein the respective fixed directions of the two stationary mounted propulsion units are such that the largest part of the respective generated thrusts is in a direction that is substantially parallel to a virtual centre line of the watercraft running from bow to stern. Hereby, a high amount of thrust can be used for moving the watercraft forward, such that it is able to sail forward in an efficient manner, which is, for instance, also an efficient setup for a watercraft that has to cover large distances.

In a preferred embodiment of the watercraft, wherein (at least) one of the stationary mounted propulsion units is, as seen in the direction towards the centre of gravity, arranged at an outward angle towards the nearest of the starboard and port side of the watercraft. Or, in other words, (at least) one of the stationary mounted propulsion units is arranged at an outward angle with respect to a virtual centre line of the watercraft running from bow to stern, such that a moment arm of the respective forward and backward thrusts is increased for generating respective increased moments around the centre of gravity of the watercraft. The one of the stationary mounted propulsion units is then preferably mainly directed in the sway direction. The increased moment arm allows for efficiently controlling the yaw rotation and/or sway motion of the watercraft at low speeds.

It is preferred that the positioning system comprises a third stationary mounted propulsion unit that is arranged for generating a forward and backward thrust with respect to said propulsion unit, and preferably wherein the third stationary mounted propulsion unit is fixed at an angle with respect to a virtual centre line of the watercraft running from bow to stern, such that the largest part of the respective thrust is in in a direction that is substantially perpendicular to the virtual centre line. A third propulsion unit enables, when oriented in particular angles with respect to each other and/or with respect to the centre of gravity or rotation, to generate any combination of forward/backward and sideway thrusts and to independently also obtain a predetermined moment around the centre of gravity or rotation. It is then further preferred that the forward direction and sideward direction span a two dimensional plane of movement of the watercraft and the controller is arranged for individually controlling the thrusts of the stationary mounted propulsion units, such that the positioning system is arranged to generate a resultant thrust in any direction of the two dimensional plane and, preferably, such that the positioning system is arranged to independently generate a moment around the centre of gravity of the watercraft. Hereby, the watercraft can navigate in the water in any translational (i.e. surge and sway) and rotational direction (i.e. yaw).

It is preferred that at least one stationary mounted propulsion unit is arranged between a central point, such as the centre of gravity and/or centre of rotation, of the watercraft and the bow of the watercraft, preferably near the bow of the watercraft, and wherein at least one stationary mounted propulsion unit is arranged between the central point of the watercraft and the stern of the watercraft, preferably near the stern of the watercraft. Hereby, large moment-arms around the centre of gravity and/or centre of rotation can be obtained for efficiently steering and maneuvering of the watercraft.

In a particular advantageous embodiment comprising three stationary mounted propulsion units, the two stationary mounted propulsion units are arranged on one side of the watercraft with respect to the central point, as seen in the surge direction, and wherein the third stationary mounted propulsion unit is mounted at the other side of the watercraft with respect to the central point, as seen in the surge direction. As an example, the two stationary mounted propulsion units are arranged between the central point of the watercraft and the stern of the watercraft, preferably near the stern of the watercraft, and, and wherein the third stationary mounted propulsion unit is mounted in a respective fixed direction wherein the largest part of the respective thrust is in in a direction that is substantially perpendicular to the virtual centre line, i.e. directed in the sway direction. Hereby, the watercraft can navigate in the water in any translational (i.e. surge and sway) and rotational direction (i.e. yaw). Also, a high amount of thrust can be used for moving the watercraft forward, such that it is able to generate sufficient speed for sailing, thus obtaining a fast and manoeuvrable watercraft that can even maintain its position efficiently. Also, in such a setup, the third stationary mounted propulsion unit can be mainly used for moving sideways. Additionally, in case one of two stationary mounted propulsion units are arranged between the central point of the watercraft and the stern of the watercraft is damaged or incapacitated, the third stationary mounted propulsion unit can be used for counteracting a moment generated around the centre of gravity by the other of two stationary mounted propulsion units are arranged between the central point of the watercraft and the stern of the watercraft (i.e. the one that is still operational) for going forward and/or can be used for steering the watercraft in the yaw direction. It is noted that the same effects are obtained if, as an example, the two stationary mounted propulsion units are arranged between the central point of the watercraft and the bow of the watercraft, preferably near the bow of the watercraft and wherein the third stationary mounted propulsion unit is arranged between the central point of the watercraft and the stern of the watercraft, preferably near the stern of the watercraft.

It is preferred that the watercraft is arranged to be steered exclusively by the stationary mounted propulsion units, and, preferably, wherein the watercraft does not comprise a rudder for steering or other steering mechanism. Hereby, the amount of moving parts can be reduced, such that construction is simplified and maintenance is reduced, while still obtaining a highly manoeuvrable watercraft that is able to maintain its (i.e. a fixed) position in the water.

Preferably, the watercraft comprises a position sensor system, wherein the position sensor system is arranged for determining a dynamic position of the watercraft and is connected to the controller that is arranged for controlling the stationary mounted propulsion units on the basis of the measured dynamic position. Hereby, a fully autonomous watercraft can be obtained with an autonomous dynamic positioning system for automatically maintaining its position in the water.

Preferably, the controller is arranged for maintaining a predetermined position of the watercraft by individually controlling the thrusts generated by the respective stationary mounted propulsion units. Thereby it is enabled to use the two (or three, or more) stationary mounted propulsion units of the watercraft to independently control its movement in the water in any translational (i.e. surge and sway) and rotational direction (i.e. yaw). Additionally, or alternatively, the position sensor system is arranged for determining an actual orientation and actual position of the watercraft and wherein said sensor system comprises at least one position sensor, such as a GPS, Galileo or similar sensor, and preferably at least one positional change sensor for determining a rate of change of the actual position of the watercraft, such as an accelerometer, gyroscope or similar sensor. A position sensor, such as a GPS, Galileo or similar sensor allows to accurately determine the position of the watercraft and by also monitoring a rate of change of the position, the controller is able to include the rate of change in determining the required thrust per propulsion unit, such that one is able to maintain the position even in, for instance, more severe weather, wave and current conditions.

In a preferred embodiment, a propulsion unit comprises a propeller and an electrical motor for driving the propeller. Such a propulsion unit may also be referred to as a thruster. A propeller can, for instance, be a symmetrical or asymmetrical propeller depending on the working conditions. An electrical motor is a compact power source that can more easily be integrated in a small boat and/or vessel and is also, due to a fast response time, more easy to control using an electronic controller when compared to a traditional combustion engine. More preferably, the propeller and the electrical motor of at least one propulsion unit are arranged in a propulsion unit housing, and/or connected to propulsion unit frame member, having a connection section for fixedly connecting the propulsion unit housing to a hull of the watercraft. Hereby, the propulsion system can also be applied as an upgrade to existing watercraft for upgrading the positioning abilities of existing ships, vessels, boats and the like.

In a further aspect, the invention relates to a method of controlling a watercraft according to any of the preceding claims, wherein the method comprises:
determining planned movement of the watercraft;
determining a required resultant thrust for achieving the planned movement;
determining a required individual thrust of the respective stationary mounted propulsion units for obtaining the required resultant thrust;
driving the stationary mounted propulsion to deliver the required individual thrust of the respective stationary mounted propulsion units.

By executing these steps, the watercraft according to the embodiments is controlled for navigating and/or maintaining its position or reaching a required target position.

It is preferred that the method further comprises:
providing a target position of the watercraft;
determining an actual position and/or rate of change of the actual position of the watercraft;
determining the planned movement of the watercraft on the basis of the target position of the watercraft and the actual position and/or rate of change of the actual position of the watercraft.

On the basis of the target position and the actual position and/or the rate of change, the controller can determine the required thrust for counteracting any undesired motion and to maintain the target position of the watercraft.

In a further aspect, the invention relates to the positioning system for use in a watercraft according to any of the preceding embodiments.

The present invention is further illustrated by the following figures, which show preferred embodiments of the watercraft, the method and the positioning system, and are not intended to limit the scope of the invention in any way, wherein:

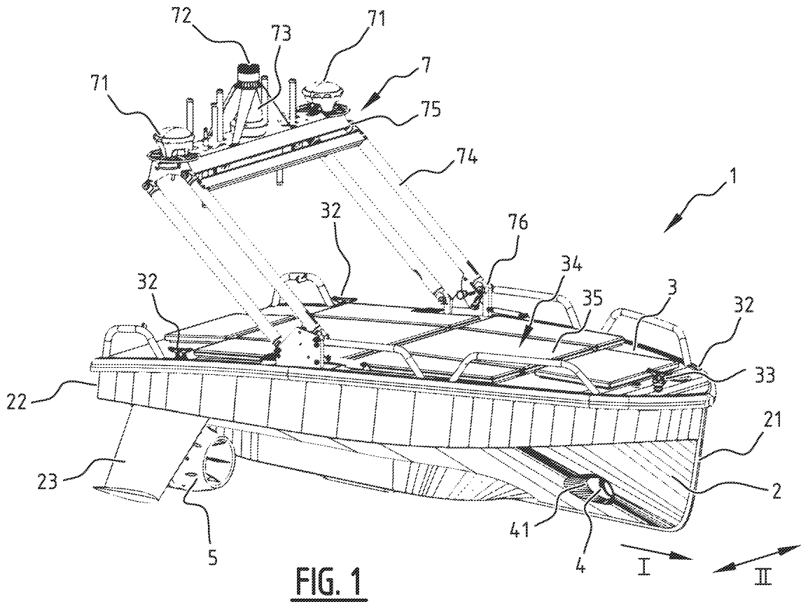

FIG. 1 shows a 3D perspective of a first embodiment of the watercraft having three stationary mounted propulsion units.

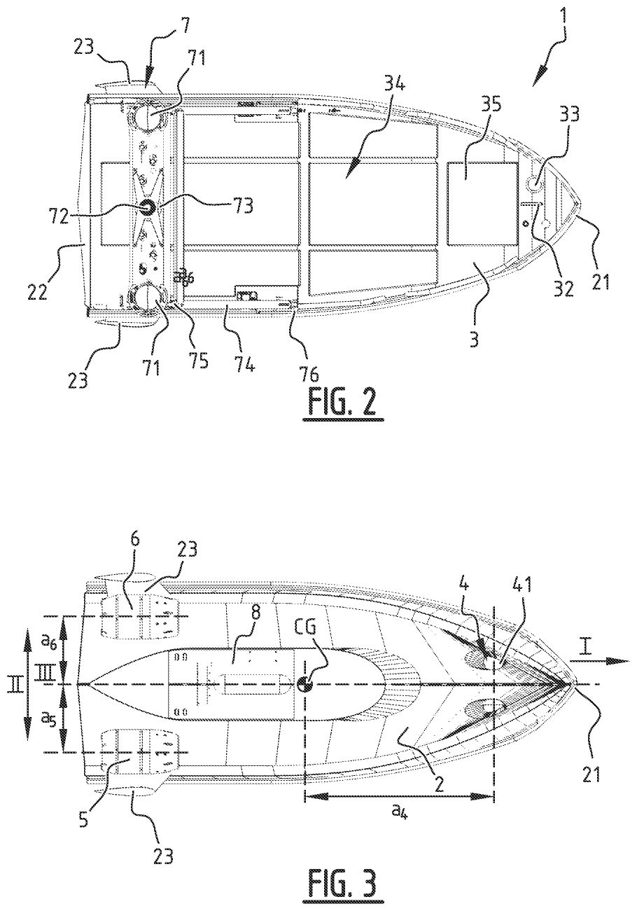

FIG. 2 shows a schematic top-view of the first embodiment of the watercraft.

FIG. 3 shows a schematic bottom view of the first embodiment of the watercraft, wherein the arrangement of the stationary mounted propulsion units is of particular interest.

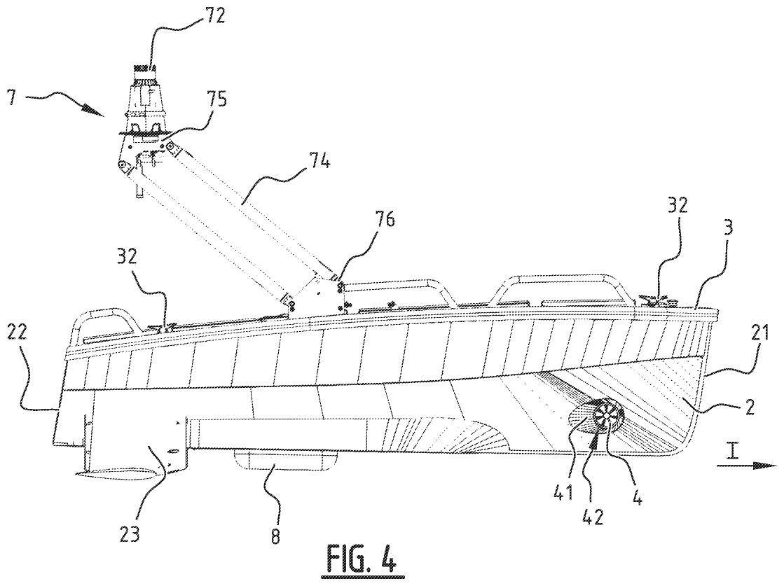

FIG. 4 shows a schematic side view of the first embodiment of the watercraft.

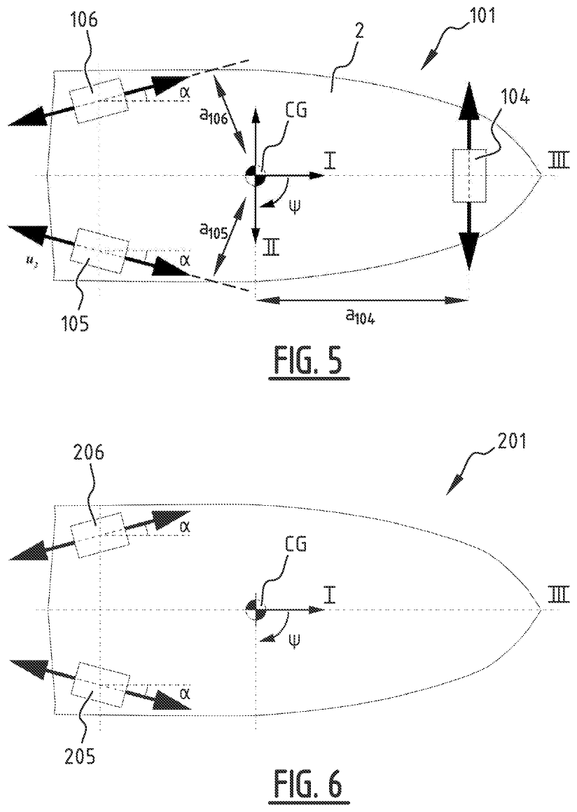

FIG. 5 shows a schematic bottom view of a second embodiment of the watercraft having an alternative arrangement of the stationary mounted propulsion units.

FIG. 6 shows a schematic bottom view of a third embodiment of the watercraft having yet another alternative arrangement of two stationary mounted propulsion units.

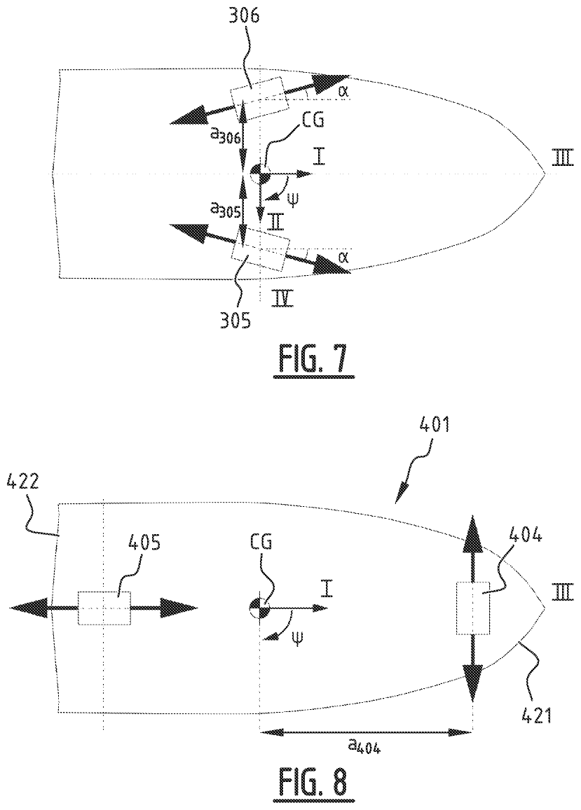

FIG. 7 shows a schematic bottom view of a fourth embodiment of the watercraft having a further alternative arrangement of two stationary mounted propulsion units.

FIG. 8 shows a schematic bottom view of a fifth embodiment of the watercraft having again a different arrangement of two stationary mounted propulsion units.

FIG. 1 shows a 3D perspective of a watercraft 1 having three stationary mounted propulsion units 4, 5, 6. The watercraft, also shown in FIGS. 2-4, is in the current embodiment a relatively small vessel 1 of approximately 2.5 m in length. The vessel 1 has a hull 2 that can be made from any suitable material, such as steel, aluminium, plastics and/or fibre-reinforced materials. A first hull mounted propulsion unit 5 is arranged for generating thrust in the forward and backward sailing directions I. A second hull mounted propulsion unit 6 (see FIGS. 3 and 4) is arranged on the other side of the vessel 1. The first and second hull mounted propulsion units 5, 6 are arranged near the stern 22 of the vessel 1. A third bow mounted propulsion unit 4 is arranged in a through hole 41 that is arranged through the hull 2 near the bow 21. The third bow mounted propulsion unit 4 is arranged to generate a thrust in the sideways directions II corresponding to the sway motion of the vessel 1, that is substantially perpendicular to the forward sailing direction I that is parallel to the surge motion of the vessel 1. The propulsion units 4, 5, 6 are thus stationary with respect to the watercraft for generating a forward and backward thrust with respect to the respective propulsion unit 4, 5, 6 in a respectively fixed direction with respect to the watercraft 1.

Also arranged near the stern 22 and the first and second hull mounted propulsion units 5, 6 are protective fins 23 that are also designed to be load bearing and to support the vessel 1 when placed on the ground, preventing damage to the first and second hull mounted propulsion units 5, 6.

The deck 3 of the vessel 1 comprises multiple bays 34 for batteries and the controller and/or additional payloads. These bays can be closed off using watertight hatches 35 for protecting the contents of the bays 34. Furthermore, a number of hoisting points 32 are provided on the deck 3 for hoisting the vessel 1 from, and into, the water. To allow for easily charging of the batteries, a charging socket 33 is provided on the deck 3.

An adjustable bridge 7 is provided wherein on the bridge sensor bracket 75 is provided for supporting a number of different sensors and/or sensor antenna's, such as GPS antenna's 71, a camera system 73 for remotely viewing the surroundings of the vessel 1. Furthermore, navigation lights 72 can be provided for low-visibility conditions. The bridge sensor bracket 75 is lockable at a number of different heights in order to obtain the best signal or view for the sensors, while allowing to pass underneath low structures, or for folding the bridge 7 to the deck 3 when transporting the vessel 1. The adjustment system of the adjustable bridge 7 comprises parallel arranged beams 74 that are mounted to the deck 3 and lockable in position by means of the bridge coupling members 76.

FIG. 3 clearly shows the mirror symmetric setup of the positioning system with respect to the mirror symmetry line III. As described above, the third, bow mounted propulsion unit 4 is arranged to generate a thrust in the sideways directions II, as is indicated by the large arrows, whereas the first and second hull mounted propulsion units 5, 6 are arranged for generating thrust in the sailing direction I, as is indicated by the large arrows. The thrust generated by the respective propulsion units 4, 5, 6 all have a respective moment arm a4, a5, a6 with respect to the centre of gravity CG of the vessel 1, such that a stand-still or close to stand-still, the vessel 1 can move independently in any direction (i.e. sway, surge and yaw) by individually controlling the thrust generated by the different propulsion units 4, 5, 6. Thereby, rudders or rotatable mounted propulsion units that can rotate the thrust in the plane defined by sway and surge are not required for maintaining the position of the vessel 1. In addition, when at speed, whereby the rotational point of the vessel 1 will typically move from the centre of gravity over the mirror symmetry line III, the vessel 1 can be regulated in speed and steered to port or starboard sides by individually controlling the thrust of the respective stationary mounted propulsion units 4, 5, 6, or even by only using and regulating the thrust of the first and second hull mounted propulsion units 5, 6. Hence, a highly manoeuvrable vessel 1 obtained that has a minimum of movable parts.

The bridge sensor 75 bracket on the bridge 7 for above water measurements and the moonpool bracket 8 for underwater measurements the system is sensor agnostic and can be equipped with different (user specific) sensors/equipment. This increases the adaptability and thereby deployability of the vessel 1 for different applications and environments.

FIG. 5 shows a schematic bottom view of a second embodiment of the watercraft 101 having an alternative arrangement of the stationary mounted propulsion units 104, 105, 106. The third forward mounted propulsion unit 104, for instance being the third bow mounted propulsion unit 4 according to the first embodiment. The first and second stationary mounted propulsion units 105, 106 are still arranged mirror symmetric with regards to the mirror symmetry line III, but are (as seen with respect to the mirror symmetry line) arranged at an outward angle α, such that the respective arms a105, a106 are increased with respect to the arrangement of the first embodiment. Hereby, the same amount of thrust leads to a larger moment around the centre of gravity CG, whereby this leads to an increase steering manoeuvrability of the vessel 1, i.e. increased response in the yaw direction ψ, at the cost of a slightly decreased energy efficiency when going straight in the surge direction I. This embodiment can move independently in any direction (i.e. surge I, sway II and yaw ψ) by individually controlling the thrust generated by the different propulsion units 104, 105, 106. Hereby, the required change of position can be effected.

FIG. 6 shows a schematic bottom view of a third embodiment of the watercraft 201 having yet another alternative arrangement of two stationary mounted propulsion units 205, 206. The third embodiment is equal to the second embodiment, with the difference that no third forward mounted propulsion unit 104 is provided. Hereby, the vessel 201 loses the ability to have a pure sideways (i.e. sway) displacement. Nonetheless, the vessel 201 is still able, by the use of only the two stationary mounted propulsion units 205, 206 to have pure rotations around the centre of gravity CG (i.e. pure yaw ψ), and a pure forward/backward movement (i.e. pure surge I). Hence, a vessel not requiring the stay on exactly the same position can be mounted with such a propulsion system.

FIG. 7 shows a schematic bottom view of a fourth embodiment of the watercraft having a further alternative arrangement of two stationary mounted propulsion units 305, 305. The difference with the third embodiment being the location of the two stationary mounted propulsion units 305, 306, and the effect of the generated thrusts on the steering properties of the vessel 1. By placing the two stationary mounted propulsion units 305, 306 symmetrically with respect to the mirror symmetry line III on a perpendicular line IV that is perpendicular to the mirror symmetry line III and that runs through the centre of gravity (and/or the rotation point) CG, sideways and sway movement can be achieved in addition to surge and sway movements.

FIG. 8 shows a schematic bottom view of a fifth embodiment of the watercraft 401 having again a different arrangement of two stationary mounted propulsion units 404, 405. Hereby, the first stationary mounted propulsion unit 405, that is mounted near the stern 422 of vessel 401 is arranged in the mirror symmetry line, i.e. central line III, such that the thrust is generated through the centre of gravity CG of the vessel 401 and thus no steering moment is generated for turning the vessel in the yaw direction ψ. The second stationary propulsion unit 404 that is mounted near the bow 421 is arranged for generating thrust in the sway direction II, thereby also (due to moment arm a404) generating a moment in the yaw direction ψ, and thus allow for steering the vessel 401.

The embodiment shown thus all do not require a rudder for manoeuvring the vessel in the water. It is noted that the present invention is not limited to the embodiment shown, but extends also to other embodiments falling within the scope of the appended claims.

1. A watercraft comprising:
a positioning system comprising a controller and at least two stationary mounted propulsion units that are stationary with respect to the watercraft for generating a forward and backward thrust with respect to the respective propulsion unit in a respectively fixed direction with respect to the watercraft;
wherein the controller is arranged for individually controlling the thrust generated by each of the two propulsion units for moving and steering the watercraft,
wherein the watercraft is arranged to be steered exclusively by the stationary mounted propulsion units, and
wherein the watercraft does not comprise a rudder for steering.

2. The watercraft according to claim 1, wherein the watercraft is an autonomously operated vessel.

3. The watercraft according to claim 1, wherein at least one of the stationary mounted propulsion units is directed such that the respective forward and backward thrusts generate respective moments around the centre of gravity of the watercraft.

4. The watercraft according to claim 1, wherein the two stationary mounted propulsion units are mounted on opposite sides of the centre of gravity of the watercraft.

5. The watercraft according to claim 1, wherein the two stationary mounted propulsion units are arranged mirror symmetric with respect to a line of mirror symmetry of the watercraft.

6. The watercraft according to claim 1, wherein the two stationary mounted propulsion units are arranged at an angle with respect to each other.

7. The watercraft according to claim 1, wherein the respective fixed directions of the two stationary mounted propulsion units are such that the largest part of the respective generated thrusts is in a direction that is substantially parallel to a virtual centre line of the watercraft running from bow to stern.

8. The watercraft according to claim 1, wherein the positioning system comprises a third stationary mounted propulsion unit that is arranged for generating a forward and backward thrust with respect to said propulsion unit, and wherein the third stationary mounted propulsion unit is fixed at an angle with respect to a virtual centre line of the watercraft running from bow to stern, such that the largest part of the respective thrust is in in a direction that is substantially perpendicular to the virtual centre line.

9. The watercraft according to claim 8, wherein the forward direction and sideward direction span a two dimensional plane of movement of the watercraft and the controller is arranged for individually controlling the thrusts of the stationary mounted propulsion units, such that the positioning system is arranged to generate a resultant thrust in any direction of the two dimensional plane.

10. The watercraft according to claim 1, wherein at least one of the stationary mounted propulsion units is, as seen in the direction towards the centre of gravity, arranged at an outward angle towards the nearest of the starboard and port side of the watercraft.

11. The watercraft according to claim 1, wherein at least one stationary mounted propulsion unit is arranged between a central point, such as the centre of gravity, of the watercraft and the bow of the watercraft, and wherein at least one stationary mounted propulsion unit is arranged between central point of the watercraft and the stern of the watercraft.

12. The watercraft according to claim 4, wherein the two stationary mounted propulsion units are arranged on one side of the watercraft with respect to the central point, as seen in the surge direction, and wherein the third stationary mounted propulsion unit is mounted at the other side of the watercraft with respect to the central point, as seen in the surge direction.

13. The watercraft according to claim 1, comprising a position sensor system, wherein the position sensor system is arranged for determining a dynamic position of the watercraft and is connected to the controller that is arranged for controlling the stationary mounted propulsion units on the basis of the measured dynamic position.

14. The watercraft according to claim 0, comprising a position sensor system, wherein the position sensor system is arranged for determining a dynamic position of the watercraft and is connected to the controller that is arranged for controlling the stationary mounted propulsion units on the basis of the measured dynamic position; wherein the controller is arranged for maintaining a predetermined position of the watercraft by individually controlling the thrusts generated by the respective stationary mounted propulsion units.

15. The watercraft according to claim 130, wherein the position sensor system is arranged for determining an actual orientation and actual position of the watercraft and wherein said sensor system comprises at least one position sensor, such as a GPS, Galileo or similar sensor.

16. The watercraft according to claim 1, wherein a propulsion unit comprises a propeller and an electrical motor for driving the propeller.

17. The watercraft according to claim 16, wherein the propeller and the electrical motor of at least one propulsion unit are arranged in a propulsion unit housing having a connection section for fixedly connecting the propulsion unit housing to a hull of the watercraft.

18. A method of controlling a watercraft according to claim 1, wherein the method comprises:
determining planned movement of the watercraft;
determining a required resultant thrust for achieving the planned movement;
determining a required individual thrust of the respective stationary mounted propulsion units for obtaining the required resultant thrust; and
driving the stationary mounted propulsion to deliver the required individual thrust of the respective stationary mounted propulsion units.

19. The method of controlling a watercraft according to claim 18, wherein the method further comprises:
providing a target position of the watercraft;
determining an actual position and/or rate of change of the actual position of the watercraft; and
determining the planned movement of the watercraft on the basis of the target position of the watercraft and the actual position and/or rate of change of the actual position of the watercraft.

20. A positioning system for use in a watercraft according to claim 1.
